(19) United States
(12) Patent Application Publication
(10) Pub. No.: US 2003/0145103 A1
(43) Pub. Date: Jul. 31, 2003

(54) Method and system for providing exactly-once semantics for web-based transaction processing

(76) Inventors: Jim Pruyne, Naperville, IL (US); Svend Frolund, Mountain View, CA (US)

Correspondence Address: HEWLETT-PACKARD COMPANY, Intellectual Property Administration, P. O. Box 272400, Fort Collins, CO, 80527-2400, US

(21) Appl. No.: 10/066,479

(22) Filed: Jan. 30, 2002

(51) Int. Cl. G06F 15/16

(52) U.S. Cl. 709/237; 714/15

(57) ABSTRACT

A method and system for providing exactly-once semantics for web-based transaction processing in a system that includes a client and a server. The client requests a form from the server. The server in response generates a unique identifier for identifying a particular transaction and provides a form with the unique identifier to the client. A user fills out the form and posts the filled out form to the server. Upon receiving the filled out form, the server generates a status page for informing the user that the transaction is being processed and returns the status page to the client. The status page includes client-side error handling logic. After returning the status page, the server performs transaction processing. In the event of failures, the error handling mechanism provides either exactly-one error handling semantics, which does not require user intervention, or at-most once error handling semantics that involves the user in error recovery.

### FIELD OF THE INVENTION

The present invention relates generally to exactly-once transactions (e-transactions), and more particularly, to a method and system for providing exactly-once semantics for web-based transaction processing.

### BACKGROUND OF THE INVENTION

In recent years, electronic commerce has exploded with the growth of the Internet. Today, many businesses offer services and product to its customers through the Internet. Since business is literally at a stand still when a company's web site is down, it is important for Internet applications to be highly available.

A common architecture for Internet applications has three tiers. The first tier includes thin front-end clients (e.g., browsers). The second tier includes stateless middletier servers (e.g., web servers). The third tier includes backend databases.

Two types of clustering are utilized to ensure high availability of such systems. First, web servers are clustered into a web server farm. Because of the stateless nature of HTTP, and of the web servers themselves, any of the web servers in the farm can service any request. In this manner, the failure of any one web server in the farm does not shut down the web site.

Second, the databases run in high-availability clusters, which in effect is clustering at the hardware level. A set of nodes in a cluster has access to a shared disk, and the clustering software monitors the database processes and restarts them as necessary.

Although the use of clustering reduces down time, clustering does not address the issue of failure transparency. When the transaction is successful, the web server returns a result (e.g., a receipt of the transaction with a confirmation number). Unfortunately, when the transaction is unsuccessful, the user may be provided only with very limited information about the nature of the failure (e.g., an error message that states “web server unavailable”).

For example, consider the situation where a web server is executing a transaction against a back end database in response to an HTTP request from a browser. If the web server crashes, the browser (and thereby the end user) receives an error message, even when other web servers are up and running. If the transaction involves an update of state in the database (e.g., purchase tickets, transfer money, etc.), the user is now left wondering what actually happened (i.e., the user is uncertain whether the update occurred before the failure of the web server).

In current web-based transaction processing systems, the following types of failure handling schemes are employed. In a first prior art scheme, users are exposed to failures and given no assistance in handling the failures. In a second prior art scheme, users are exposed to failures and provided warnings about certain actions from which to refrain.

For example, when a user submits a form to start a transaction, the web server may return a page with a warning that sets forth the dangers of re-submitting the form. Unfortunately, the user is not empowered with a safe retry mechanism. Instead, the user may be told to contact customer service in the case of failures. Some systems provide a transaction identification number to the user. This identification number may be used when interacting with customer service.

Consequently, it is desirable for there to be a mechanism that provides automatic retry without user intervention. It is also desirable for there to be a mechanism that provides the user with safe retry options in situations where the retry is not automated.

Some approaches utilize software in addition to the browser on the client side to perform error handling. This software can be, for example, applets (e.g., browser plug-ins). One disadvantage of this approach is that the additional client-side software first needs to be downloaded and installed on the client before the error handling is in effect. Unfortunately, many users are reluctant to install browser plug-in programs, thereby severely limiting the effectiveness of this approach.

Consequently, it is desirable for there to be an error handling mechanism that does not require additional client-side software other than the browser.

Based on the foregoing, there remains a need for a method and system for providing exactly-once semantics for web-based transaction processing.

### SUMMARY OF THE INVENTION

According to one embodiment of the present invention, a method and system for providing exactly-once semantics for web-based transaction processing are described.

One aspect of the present invention is the provision of a mechanism for providing automatic retry without user intervention for many failure situations.

Another aspect of the present invention is the provision of mechanism for providing a safe retry that involves user assistance in other failure situations.

According to one embodiment, a method for providing error handling for web-based transaction processing is provided. The system includes a client and a server. The client requests a form from the server. The server in response generates a unique identifier for identifying a particular transaction and provides a form with the unique identifier to the client. A user fills out the form and posts the filled out form to the server. Upon receiving the filled out form, the server generates a status page for informing the user that the transaction is being processed and returns the status page to the client. The status page includes client-side error handling logic. After returning the status page, the server performs transaction processing. In the event of failures, the error handling mechanism provides either exactly-once error handling semantics, which does not require user intervention, or at-most once error handling semantics that involves the user in error recovery.

Other features and advantages of the present invention will be apparent from the detailed description that follows.

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates a web-transaction processing system according to one embodiment of the present invention.

FIG. 2 illustrates an interaction protocol for processing web-transactions according to one embodiment of the present invention.

FIG. 3 is a block diagram illustrating in greater detail the error handling mechanism of FIG. 1 according to one embodiment of the present invention.

FIG. 4 illustrates exemplary server-side logic according to one embodiment of the present invention.

FIG. 5 illustrates exemplary servlets for implementing the interaction protocol of FIG. 2.

### DETAILED DESCRIPTION

A method and system for providing exactly-once semantics for web-based transaction processing are described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

One aspect of the present invention is to isolate users from the handling of errors. For user-initiated transactions, the transaction processing of the present invention provides isolation from errors by employing exactly-once semantics. Specifically, the error handling mechanism of the present invention provides exactly-once transactions (e-transactions) for the web environment (e.g., the Internet).

Web-Transaction Processing System

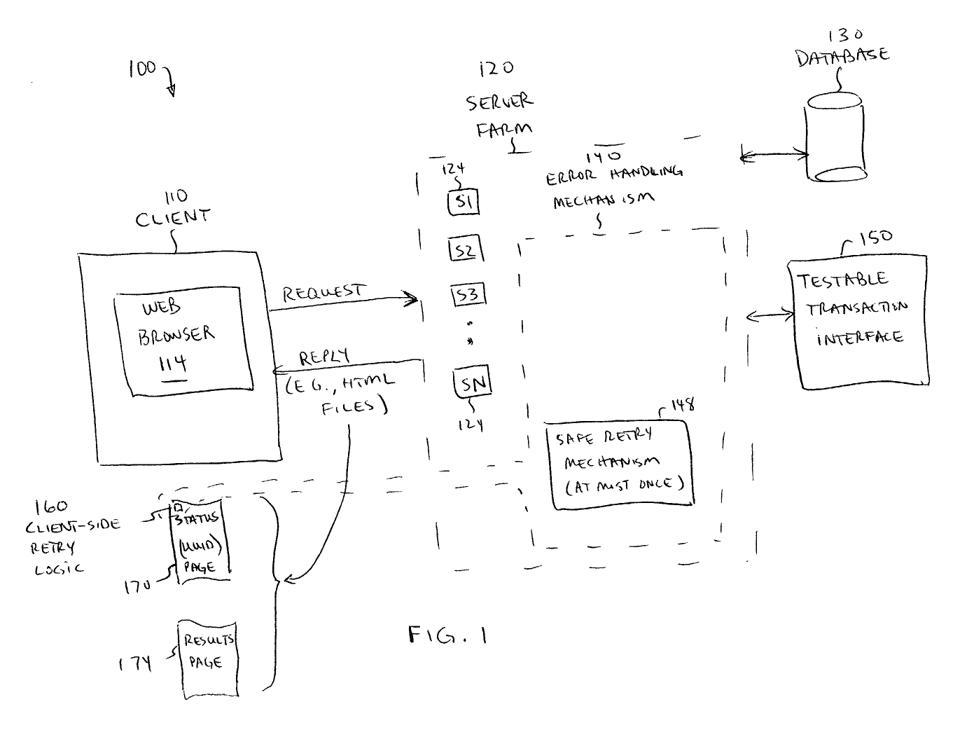

FIG. 1 illustrates a web-transaction processing system 100 according to one embodiment of the present invention. The system 100 includes a client 110 that can include a web browser 114 and a server farm 120 that includes at least one server 124 (e.g., a web server). The web browser 114 requests pages in a mark-up language from web servers (e.g., web server 124) by employing a predetermined client-server protocol. For example, the client-server protocol can be a request-reply protocol in which the server only responds to client requests (i.e., the server cannot notify the client without a client request). Preferably, the predetermined client-server protocol between the browser 114 and the servers 120 is HTTP, and the content is in standard HTML.

It is noted that any available web server (e.g., servers S1, S2, . . . , SN) can respond to a request from the web browser 114.

In order to execute browser requests, the web server 124 runs transactions against a database 130 (e.g., shared database). For example, in response to certain page requests, the web server 124 may start a transaction against a back-end database. For example, a database 130 may allow XA-style transaction control. For further details regarding the XA-style transaction control, please refer to a publication entitled, “Distributed Transaction Processing”: The XA Specification, x/Open Company Ltd., XO/SNAP/91/050, 1991. A start method is used to initiate transactions. Commit or abort methods are used to terminate the transaction.

In this embodiment of the present invention, the XA-based termination is augmented with a testable transaction. A testable transaction is a transaction whose outcome (e.g., commit or abort) and result (e.g., a value produced by the transaction's SQL statements) can be determined in a fault-tolerant and highly-available manner. For example, in the case of a single backend database, the testable interface may be layered on top of the XA transaction handling mechanism. The implementation of a testable transaction on top of a single standard database is described in greater detail hereinafter.

One method to implement a testable transaction is described in a paper entitled, “A Pragmatic Implementation of e-Transactions,” by Svend Frolund & Rachid Guerraoui that was published at the IEEE symposium on Reliable Distributed Systems (SRDS) in October 2001 in Nurnberg, Germany. This paper describes how to implement a log table in a database, and then to store the transaction identifier (UUID) and result in this log table. The commit method then inserts the UUID and result into the table as part of the transaction itself. Because the insertion is done as part of the transaction, the log table update (i.e., inserting the result and UUID) and the transactional changes (e.g., business logic) occur as an atomic action. Consequently, the transactional effect takes place, if and only if the UUID and result are stored in the log table. In this manner, get-outcome may be implemented as looking for a given UUID in the table.

It is noted that a rollback is simply a matter of invoking the XA rollback. This implementation works for a single database that supports a notion of global transaction (i.e., a transaction whose identity is valid across application servers). XA provides this notion of global transaction.

The web servers 124 are preferably configured as a web server farm 120 that is accessed through a single Distributed Name Service (DNS) entry. The web server farm configuration ensures that at any time, there is at least one web server that is operational and available to process requests. The DNS name resolution eventually resolves the name of the web-server farm to an operational web server. When a web server that is utilized by a browser crashes, the browser eventually re-submits the request, which is then delivered to an operational web server.

The web server 124 can fail by crashing. For example, the web server 124 executes its prescribed behavior until the server crashes. To address this issue, the system 100 includes an error handling mechanism 140 of the present invention. In this embodiment, the error handling mechanism 140 of the present invention includes a client-side retry logic 160 that may be embedded in a status page 170 and a server side handling mechanism 148, which is described in greater detail hereinafter.

The server-side error handling mechanism 148 employs at-most once semantics (hereinafter also referred to as a safe retry mechanism) for performing error recovery with user assistance.

The client-side retry logic 160 includes an error handling mechanism that employs at-least one semantics. The client-side retry logic 160 is also referred to herein as an automatic retry mechanism for performing error recovery without user intervention. The automatic retry mechanism 160 automatically re-tries transactions, whose previous transaction attempts have an outcome of abort without user intervention. The automatic retry mechanism 160 preferably performs a retry at a predetermined time interval until the outcome is a commit. As described in greater detail hereinafter, the automatic retry mechanism 160 employs a unique identifier for identifying a particular transaction.

The safe retry mechanism 148 is utilized in situations where retry is not automated. The safe retry mechanism 148 enables a user to safely retry a transaction that previously failed. With safe retry, errors are visible to the user. However, the safe retry mechanism 148 enables users to determine the outcome (e.g., abort or commit) of the transaction through interaction with a web site. For example, a user may follow a link to an “Outcome Determination” page, where the outcome of a transaction may be retrieved. The safe retry mechanism 148 provides a user-assisted error handling mechanism that is more advantageous than prior art approaches, in which the user's option is not limited to calling or contacting customer service in the event of a failure.

It is noted that the error handling mechanism 140 of the present invention provides exactly-once semantics (i.e., e-transaction semantics) except in a small number of failure cases. It is noted that the combined operation of the safe retry mechanism 148 and the automatic retry mechanism 160 provides exactly-once semantics. In a small number of cases, the error handling mechanism 140 of the present invention ensures at-most-once semantics instead of exactly-once semantics.

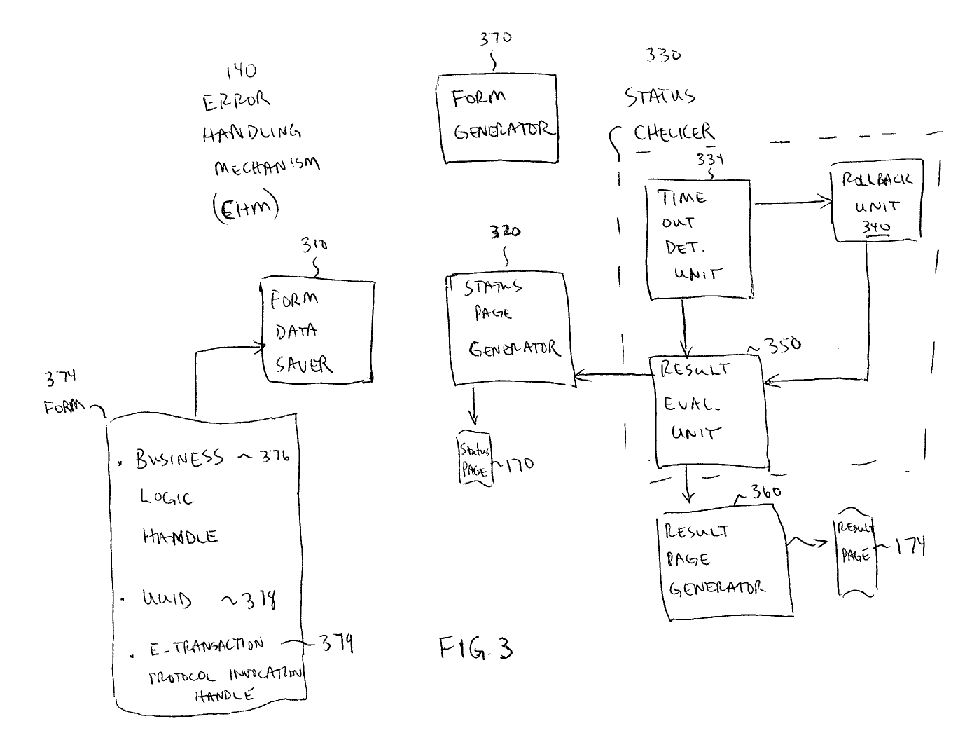

The error handling mechanism 140 in response to requests by the client browser 114 generates a form page, which is described in greater detail hereinafter with reference to FIG. 3, a status page 170, and a results page 174. The status page 170 can include the client side retry logic 160 and the transaction identifier (UUID). The client side retry logic 160 includes an automatic retry mechanism (e.g., client side retry logic 160) that provides at least once semantics. The client side retry logic 160 is preferably downloaded into the client as part of the status page 170.

FIG. 3 is a block diagram illustrating in greater detail the error handling mechanism (EHM) 140 of FIG. 1 according to one embodiment of the present invention. The EHM 140 includes a form data saver 310 for saving form data and a status page generator 320 for generating a status page that includes a UUID.

According to one embodiment of the present invention, data is embedded in the status page, and provided to the user in a transparent manner (i.e., the data is transparent to the user). The data is then passed back to the server when the status page reloads. This approach is especially appropriate when the data is small. In an alternative approach, the data is stored in a database. However, it is preferable that the data be highly available (e.g., the data should be accessible from all application servers).

The EHM 140 further includes a status checker 330 for prior to re-executing server-side business logic, checking the status of previously executed transaction with the same transaction identifier. The status checker 330 includes a time out determination unit 334 for determining if a predetermined time out has elapsed. A rollback unit 340 is provided for canceling transactions that are active. It is noted that the rollback operation is not performed unless the elapsed time is greater than or equal to a predetermined time interval (i.e., the time out value).

A result evaluation unit 350 is provided for obtaining the result of a particular transaction and for determining whether the result is nil. When the result is not nil, a result page generator 360 is employed to provide the results to the client browser. When the result is nil, the status page generator 320 is utilized to provide another status page to the client browser.

A form generator 370 is provided for generating forms (e.g., form 374). The form 374 can include a business logic handle 376, an identifier (UUID) 378, and an e-transaction protocol invocation handle 379.

One advantage of the present invention is that the error handling protocol utilizes pure web technologies, such as HTTP and HTML, without the requirement of client side logic (e.g., applets in the form of browser plug-ins). In this manner the error handling protocol may be utilized with standard browsers and with standard content-delivery methods without additional client-side logic. In contrast, some prior art approaches require the browser to download and execute applets (e.g., browser plug-ins), which users may be reluctant to download and install.

The functionality of a testable transaction is available through the interface set forth in TABLE I.

TABLE I
void rollback (UUID);
Result get-outcome (UUID;)
}

The commit method attempts to commit a given transaction with a given result. The get-outcome method receives a transaction identifier and returns the result for that transaction, if any. When the get-outcome returns a nil, no result has yet been committed for that transaction. The rollback method terminates a given transaction without committing it. Transaction identifiers are global in that one web server can call commit and another web-server can call get-outcome for the same transaction. Furthermore, the outcome and result information is highly available in that a first web server can commit a transaction, and another web server can determine the outcome and result of the transaction independently of the first web server (i.e., even if the first web server crashes).

In order to provide exactly-once semantics for transactions, it is assumed that any transaction eventually completes execution and generates a result. Also, the database is allowed to fail an arbitrary number of times. However, it is assumed that the database eventually stays up long enough to execute transactions to completion.

Interaction Protocol

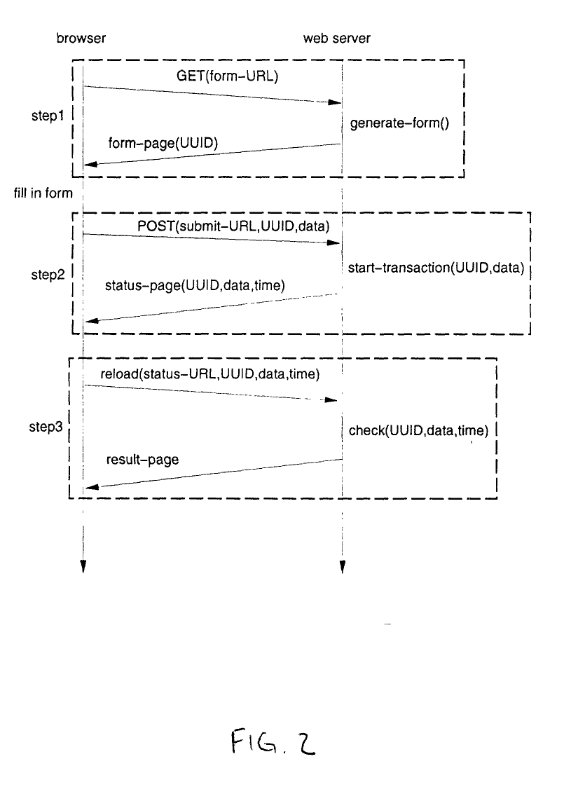

FIG. 2 illustrates an interaction protocol for processing web-transactions according to one embodiment of the present invention. The following describes the processing steps of the interaction protocol of the present invention without failures (i.e., failure-free execution). As described previously, in this embodiment, since the protocol is based on HTTP, the protocol includes a number of request-reply interactions between the client and server. Referring to FIG. 2, the interactions are contained in dashed boxes and denoted as step1, step2, and step3, respectively.

In the first step of the protocol (stepl), the client requests a web page that contains a form, which is to be submitted with exactly-once semantics. The URL of this form is form-URL.

Server-Side Logic

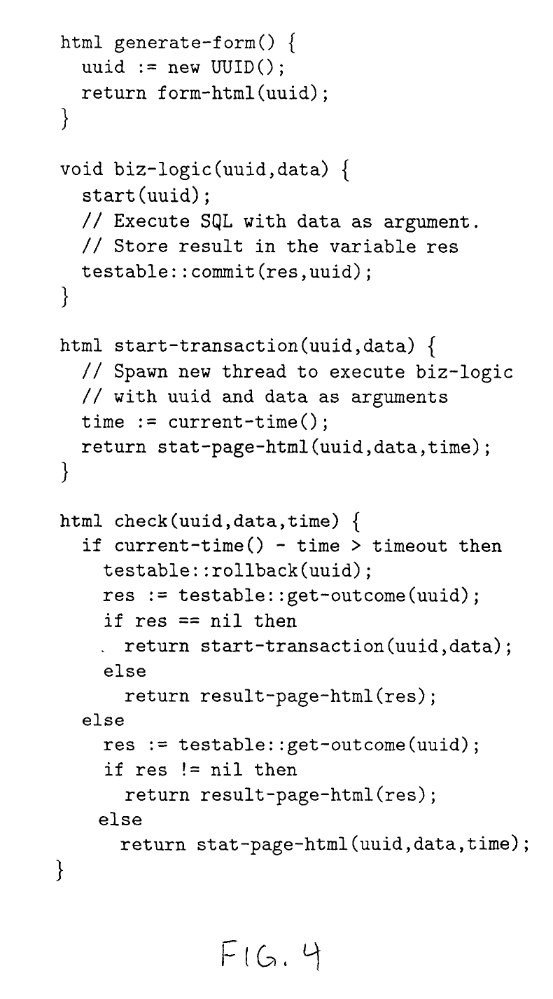

FIG. 4 illustrates exemplary server-side logic according to one embodiment of the present invention. The server first generates a globally unique identifier (UUID) and then embeds the generated UUID in the HTML page that is returned to the client 110 of FIG. 1 (e.g., web browser). It is noted that the HTML “form-page(UUID)” returned to the client may be generated by the “form-html(uuid)” method, which is described in greater detail hereinafter with reference FIG. 3.

The UUID is utilized as an identifier for the server-side transaction that processes the form data. The client (e.g., web browser) passes the UUID back to the server when the browser submits the form.

For example, the UUID may be stored in an in-memory cookie in the browser, or the UUID may be stored in the URL that the client employs to submit the form. The URL may be part of the server-generated form.

When the browser receives the form page with the embedded UUID, the browser renders the page. The user can then fill in the form. When the user has finished entering the form data, the user submits the form (e.g., by selecting a button in the form), thereby sending the form data to the web server for processing.

It is noted that the server-side processing is transactional, and the error handling mechanism of the present invention provides exactly-once semantics for this transaction. When the user submits the filled-in form, the web browser sends the filled-in form to the web server with an HTTP POST request. In response to this request, the server executes the start-transaction method. The start-transaction method asynchronously launches a transaction to execute the business logic (e.g., the business logic described in the method called biz-logic). After launching the transaction, the server returns a status page to the browser.

The status page informs the user that the transaction is in progress. The status page is set to automatically reload after a predetermined time interval (e.g., a few seconds) using the appropriate HTML tag.

For example, when the result is not ready, another status page is returned to the user. The first and second status pages are generally identical, except perhaps for a different text message to the user (e.g., “please be patient, the result is almost ready”). The first status page may be overwritten by the second or next status page. This replacement process may be visible to the user.

The user may also manually reload the page by issuing a page refresh command. Reloading the status page, whether automatically or manually initiated by a user, executes the server-side method called check. The check method checks the status of the server-side transaction.

The status page includes the UUID for the transaction in order to identify the transaction properly. When the status page is reloaded, the UUID is passed back to the server. Furthermore, the status page includes the form data so that the transaction can be retried in the event that the previous transaction with the same UUID is determined to have failed.

Preferably, the status page also includes a timestamp that the server can utilize to determine if a predetermined timeout period has elapsed since the transaction was launched.

The automatic retry module causes automatically reloads the status page, thereby causing the browser to check the status of the server-side transaction without user intervention.

The check method can include the following processing steps. First, a determination is made whether the transaction has been active for less than a predetermined time out value. When the transaction has been active for less than a predetermined time out value, the check method invokes the get-outcome method to determine if the transaction has generated a result. When the get-outcome method returns a nil, the transaction may still be active or that transaction may have failed (e.g., crashed) before committing.

The check method calls rollback in order to distinguish between the two cases: 1) the transaction being active or 2) the transaction failed (e.g., crashed) before committing. However, the check method employs a timestamp in order to allow sufficient time for the transaction to execute before canceling the transaction. For example, the timestamp may be utilized to determine whether to check by calling get-outcome or to check after canceling by first calling rollback. When it is determined that the transaction did not commit, and will not commit because the transaction has been canceled, the transaction is retried.

In FIG. 2, it is assumed that the transaction has committed and stored its result in the testable transaction abstraction. Consequently, the first call to get-outcome within the check method returns a non-nil result, which is then returned to the browser as part of the result page.

Failure Handling

Getting the form (stepl of FIG. 2) from the server is idempotent and does not require any failure handling beyond a manual reload by the user. The term “idempotent” refers to a property of computations. The property is that one can execute the computation n times, but the effect (e.g., state update) is as if the computation is performed only once. An example of an idempotent computation is a read-only computation. It is noted that form generation is idempotent because form generation does not update the database.

As described in greater detail hereinafter, the e-transaction protocol of the present invention makes the server-side computation idempotent since the server first checks if it has already performed the underlying update before retrying the transaction. In this manner, the server-side logic performs an update to the database only once.

During a second step (step2 of FIG. 2), when the browser uses a web server that fails during the second step, there are two possible cases to consider. In the first case, the browser receives the status page. In the second case, the browser does not receive the status page.

When the browser receives the status page, the reload logic for the status page performs the check against another web server. In other words, the fail-over from one web server to another is handled by the DNS resolution against the cluster of web servers.

When the browser does not receive the status page, the browser eventually times out and displays an error message to the user. In this situation, the user is needed in the failure recovery process. For example, the URL of the status page may be embedded in the form as a link, and instructions directing the user to follow that link in the case of errors. These instructions may be included as part of the form.

When the third step (step3 of FIG. 2) fails, a user can simply re-load the status page manually. It is noted that reloading the status page n times has at-most-once semantics since the server-side logic in the check method launches a new transaction only if all previous attempts have failed.

Applying Web e-Transactions to Java Servlets

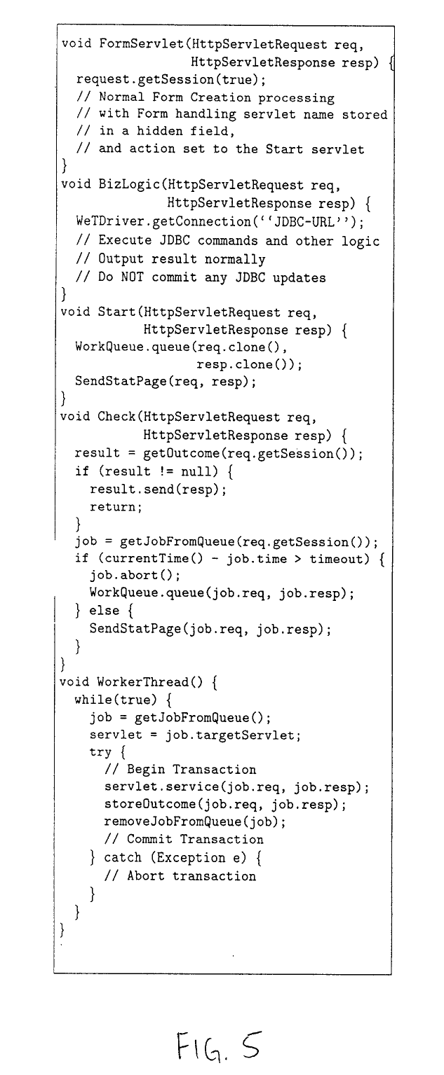

FIG. 5 illustrates exemplary servlets for implementing the interaction protocol of FIG. 2. A prototype of the web e-transaction protocol of the present invention may be implemented by using Java Servlets. Servlets are a server-side programming model for executing logic in response to web-based HTTP requests that is similar to Common Gateway Interface (CGI). The Java Servlet platform is suited for a three-tier environment that is described previously. Further information regarding Java servlet technology is provided at http://java.sun.com/products/servlet/index.html. Servlets are provided with parameters to the HTTP request via a HttpServletRequest and produce output including an HTML stream to be rendered by the browser via a HttpServletResponse object.

Referring to FIG. 5, an example is provided that illustrates how the server-side logic of FIG. 4 may be adapted to the servlet model without significant changes. Full Java syntax is not employed and certain Java programming details, such as synchronization points, are omitted, in order not to unnecessarily obscure the teachings of the present invention.

The first two methods, FormServlet and BizLogic, are intended to represent the servlets for generating and processing the form, respectively. These servlets are created as part of the web application and are independent of the web e-transaction protocol. For example, these servlets may be developed prior to the introduction of the e-transaction protocol of the present invention. Some minor modifications to these servlets that enable the e-transaction protocol are now described.

The FormServlet servlet creates a session for the user. The session is used to identify the user's operations. The generated form is modified so that the e-transaction protocol handling logic is invoked rather than directly invoking the form handling BizLogic servlet. In this example, the form servlet is changed to invoke the Start servlet. Also, the name of the Bizlogic servlet is embedded as a hidden field in the form to inform the Start servlet of the proper logic to handle the form.

The bizlogic servlet is modified only in how it interacts with the database tier. In this example, JDBC is utilized to send SQL statements to the database. Further information regarding JDBC technology is provided at http ://java. sun.com/products/jdbc/index.html.

The e-transaction protocol requires that the result of the servlet call (which is the HttpServlet Response object at the end of the method) be committed atomically with the updates performed by the business logic. One manner to accomplish this task is to obtain a database connection from a pool managed by the protocol implementation via a call to WetDriver.getConnection. Upon completion, it is determined which connection is utilized by the call, for example, by storing some information in thread local storage, and the transaction is aborted or committed as needed. Preferably, the servlet does not perform the commit operation, but instead the commit operation is performed on behalf of the servlet as described herein below.

The Start servlet is called when a form is received from the client browser. The Start servlet queues the incoming form data and returns a status page to the client browser. Preferably, the Start servlet performs these steps quickly because the interval during which the Start servlet is running is a window of vulnerability (i.e., the web server may crash during this time period, in which case user involvement is needed in the error handling).

It is important to ensure that the form data is not lost. A first approach to prevent loss of form data is to embed the form data in the status page that is returned to the client browser. A second approach to prevent loss of form data is to store the form data in a persistent location, such as a database, as part of the queuing process. The first approach creates a larger HTML stream that needs to be returned to the client browser, thereby incurring some processing overhead. Although the second approach does not have the processing overhead of the first approach, the second approach does involve interaction with the database, which may increase the vulnerability window.

The status page causes the browser to automatically invoke the Check servlet after a short delay via the HTML meta-operation “refresh”. The algorithm of the Check servlet is the same as that described in FIG. 3. The session may be used to search for outcomes in place of UUID utilized in the code of FIG. 3.

One or more instances of the WorkerThread are running in the background. These threads remove service requests Gobs) from the work queue and invoke the servlet associated with the request. An important role of the worker threads is to insure that transactions are properly committed or aborted.

Before invoking the servlet, a transactional context is initiated. When the servlet executes normally (i.e., no exceptions are thrown), the thread stores the result to the database, and commits both the result and the servlet's operations. In the event of an exception, the transaction is aborted. In the event of a servlet failure, one of following can be performed. The job can be re-queued up to a predetermined maximum number of re-tries. Alternatively, a result that signals a permanent failure may be generated and provided to the user. When such a failure notification is generated, the user has the benefit of knowing that no operations of the transaction were committed.

It is noted that this logic needs to be implemented only once. Thereafter, the e-transaction protocol logic of the present invention may be applied to any number of form generating and business logic servlets.

Examples of web-based transaction processing systems in which the error handling mechanism of the present invention can be implemented include electronic banking, electronic investment, and electronic sale and purchase of products and services (e.g., an Internet-based ticket purchase application).

It is noted that the applications are generally transactional web sites, where the HTTP interaction results in backend transactional updates. These applications can either be B2C, where the transaction is started by a user that activates a submit button, or it can be B2B transactions, where the HTTP transaction is initiated by another system.

One aspect of the present invention is the use of only the semantics of HTML and HTTP to implement the client-side retry logic and a standard browser without additional applets, plug-ins, etc.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

What is claimed is:

1. A method for providing exactly-once semantics for web-based transaction processing in a system having a client and a server, comprising the steps of:
a) the client requesting a form from the server;
b) the server generating a unique identifier for identifying a particular transaction;
c) the server providing a form with the unique identifier to the client;
d) posting a filled out form to the server; wherein the filled out form includes the unique identifier;
e) upon receiving the filled out form, the server generating a status page for informing the user that the transaction is being processed and returning the status page to the client; and
f) after returning the status page, the server performing transaction processing.

2. The method of claim 1 wherein the step of after returning the status page, the server performing transaction processing includes
checking to determine if there is a transaction with the current unique identifier that has already been committed.

3. The method of claim 2 wherein the step of checking to determine if there is a transaction with the current unique identifier that has already been committed includes the steps of
performing a rollback operation on in-progress transactions with the same unique identifier; and
determining the result and outcome of transactions that have the same unique identifier.

4. The method of claim 3 wherein when the outcome is abort, executing a new transaction with the same form data.

5. The method of claim 3 wherein when the outcome is commit, providing the result to the client.

6. The method of claim 5 wherein the step of when the outcome is commit, providing the result to the client includes the steps of
providing the transaction outcome to a testable transaction abstraction; and
providing the transaction result to the testable transaction abstraction;
wherein the transaction outcome and the transaction result of the transaction are highly available.

7. The method of claim 1 further comprising the step of:
storing the unique identifier in a uniform resource locator (URL).

8. The method of claim 1 further comprising the step of:
storing the unique identifier in a browser cookie.

9. The method of claim 1 wherein the form provided to the client in step c) includes at least one instruction that instructs the user to reload the current page when a failure message is displayed.

10. The method of claim 1 wherein posting the filled out form to the server includes the step of a user filling out the form.

11. The method of claim 1 further comprising the step of
automatically reloading the status page after a predetermined time interval; wherein the client can automatically check the status of a transaction without user involvement.

12. The method of claim 1 wherein the status page includes the unique identifier and form data.

13. The method of claim 1 wherein the step of after returning the status page, the server performs transaction processing includes
executing server-side business logic.

14. The method of claim 1 wherein the client includes a web browser.

15. A web-transaction processing system for providing exactly-once semantics for web-based transaction processing comprising:
a) a client for requesting a form from the server and allowing a user to fill out and submit forms; and
b) at least one server for generating a unique identifier for identifying a particular transaction; providing a form with the unique identifier to the client; upon receiving the filled out form, the server generating a status page for informing the user that the transaction is being processed and returning the status page to the client; and after returning the status page, the server performing transaction processing.

16. The web-transaction processing system of claim 15 further comprising:
a) an automatic retry mechanism for automatically retrying transactions whose previous transaction attempts have an outcome of abort without user intervention; wherein the automatic retry mechanism employs a unique identifier for identifying a particular transaction.

17. The web-transaction processing system of claim 16 wherein the automatic retry mechanism performs a retry at a predetermined time interval until the outcome is a commit.

18. The web-transaction processing system of claim 15 further comprising:
a mechanism for enabling a user to safely retry a transaction that previously failed.

19. The web-transaction processing system of claim 15 further comprising:
a status checking module for prior to re-executing server-side business logic, checking the status of previously executed transaction with the same transaction identifier.

20. The web-transaction processing system of claim 15 further comprising:
a status update module for when the outcome is commit, providing the transaction outcome to a testable transaction abstraction, providing the transaction result to the testable transaction abstraction, and providing the result to the client;
wherein the outcome and the result of the transaction is highly available.

21. A method for handling errors in applications that employ a request-reply protocol in a system having a client and a server, comprising the steps of:
a) the client requesting a form from the server;
b) the server generating a unique identifier for identifying a particular transaction and providing the form to the client; wherein the form includes the unique identifier;
c) the client filling out the form and providing the filled out form to the server;
d) the server generating a status page to the client;
e) when the client has received a status page, the client automatically checking the status of the transaction, when the transaction has failed, the client retrying the transactions after a predetermined time interval without user involvement providing exactly-once semantics;
f) when the client has not received the status page, involving the user in error handling by providing at-most once semantics.

22. The method of claim 21 wherein the step of when the client has not received the status page, involving the user in error handling by providing at-most once semantics includes:
instructing a user to follow a predetermined link to a status page.

23. The method of claim 21 wherein the client-side retry mechanism is implemented by utilizing HTML and HTTP semantics; and
wherein the client-side error handling mechanism is embedded in downloaded pages.
